(19) United States
(12) Patent Application Publication
(10) Pub. No.: US 2026/0321717 A1
(43) Pub. Date: Oct. 15, 2026

(54) ALKALI METAL ELEMENT-CONTAINING HALIDE, ELECTROLYTE, BATTERY, AND METHOD FOR PRODUCING HALIDE SOLID ELECTROLYTE

(71) Applicants: SUMITOMO CHEMICAL COMPANY, LIMITED, Tokyo (JP); Kyoto University, Kyoto (JP)

(72) Inventors: Atsunori DOI, Tsukuba-shi, Ibaraki (JP); Takahiro HIRAI, Niihama-shi, Ehime (JP); Hiroshi KAGEYAMA, Kyoto-shi, Kyoto (JP); Cedric TASSEL, Kyoto-shi, Kyoto (JP); Fenghua DING, Kyoto-shi, Kyoto (JP)

(21) Appl. No.: 19/109,290

(22) PCT Filed: Sep. 7, 2023
(86) PCT No.: PCT/JP2023/032725

§ 371 Date: Mar. 6, 2025

(30) Foreign Application Priority Data
Sep. 12, 2022 (JP) 2022-144853
Feb. 22, 2023 (JP) 2023-026409

(51) Int. Cl. H01M 10/0562; C01D 3/04

(52) U.S. Cl. CPC H01M 10/0562; C01D 3/04; C01P 2002/72; C01P 2002/76; C01P 2006/40; H01M 2300/008

(57) ABSTRACT

Provided is a compound containing: an alkali metal element; at least one metal element M selected from the group consisting of Mg, Ca, Sr, Ba, Zn, Sc, La, Ce, Pr, Nd, Pm, Sm, Eu, Gd, Tb, Dy, Ho, Er, Yb, Lu, Y, Al, Ga, In, Bi, Sb, Ge, Ti, Zr, Hf, Sn, Nb, Ta, and W; and a halogen element, in which the compound has a crystal structure belonging to a space group P6₃mc.

### TECHNICAL FIELD

The present disclosure relates to an alkali metal element-containing halide, an electrolyte, a battery, and a method for producing a halide solid electrolyte

### BACKGROUND ART

In recent years, solid electrolytes have attracted attention as electrolytes used in electrochemical devices such as lithium ion batteries (Patent Literatures 1 to 3). Since the solid electrolytes are excellent in high-temperature resistance, high voltage resistance, and the like as compared to conventional electrolytic solutions, it is considered that the solid electrolytes are useful for improving battery performance such as safety, high capacity, rapid charging and discharging, and pack energy density.

As described in Literatures 1 to 3, halide solid electrolytes containing lithium and metal elements other than lithium are known as materials used for solid electrolytes of lithium ion batteries. A halide solid electrolyte does not require sintering because of high flexibility, and has high safety because of not releasing harmful substances such as H₂S, and the like, which are advantages not found in oxide-based or sulfide-based solid electrolytes.

### CITATION LIST

### Patent Literature

Patent Literature 1: WO 2020137026 A
Patent Literature 2: WO 2022032311 A
Patent Literature 3: WO 2021234416 A

### SUMMARY OF INVENTION

### Technical Problem

However, the halide solid electrolyte has room for improvement in ionic conductivity.

The present disclosure has been made in view of the above circumstances, and an object of the present disclosure is to provide an alkali metal element-containing halide excellent in ionic conductivity, a method for producing a halide solid electrolyte, an electrolyte containing the same, and a battery.

### Solution to Problem

The present disclosure includes the following embodiments [1] to [10].
[1] A compound containing: an alkali metal element; at least one metal element M selected from the group consisting of Mg, Ca, Sr, Ba, Zn, Sc, La, Ce, Pr, Nd, Pm, Sm, Eu, Gd, Tb, Dy, Ho, Er, Yb, Lu, Y, Al, Ga, In, Bi, Sb, Ge, Ti, Zr, Hf, Sn, Nb, Ta, and W; and a halogen element, in which the compound has a crystal structure belonging to a space group P6₃mc.
[2] The compound according to [2], in which the halogen element contains Cl.
[3] The compound according to [1] or [2], in which the metal element includes a trivalent metal element.
[4] The compound according to any one of [1] to [3], in which the compound is represented by Composition Formula (1),

A_{α}M_{β}X_{γ} (1)
(where, A is an alkali metal element, X is a halogen element, and 1≤α≤4, 0.5≤β≤2, and 4≤γ≤8).
[5] The compound according to any one of [1] to [4], in which the metal element M includes at least one element selected from the group consisting of Al, Ga, In, Sc, La, and Y.
[6] The compound according to any one of [1] to [5], in which the metal element M includes two or more metal elements.
[7] The compound according to any one of [1] to [6], in which the halogen element includes two or more halogen elements.
[8] An electrolyte including the compound according to any one of [1] to [7].
[9] A battery including the electrolyte according to [8].
[10] A method for producing a halide solid electrolyte, the method including a step of heating a raw material under a pressure of 1 GPa or higher.

### Advantageous Effects of Invention

According to the present disclosure, it is possible to provide the alkali metal element-containing halide excellent in ionic conductivity, the method for producing a halide solid electrolyte, the electrolyte containing the same, and the battery.

### BRIEF DESCRIPTION OF DRAWINGS

FIG. 1 is a diagram illustrating a result of single crystal X-ray diffraction measurement corresponding to a c-axis direction (001 direction) for a sample of Example 1.

FIG. 2 illustrates powder X-ray diffraction patterns of samples of Examples 1 to 4.

FIG. 3 is a powder X-ray diffraction chart for three crystal polymorphs of Li₃ScCl₆.

FIG. 4 is a ball-and-stick and polyhedral representation of the structure of γ-Li₃ScCl₆.

FIG. 5 is a Cole-Cole plot of ionic conductivity of Example 3.

FIG. 6 is a diagram illustrating the results of a charge and discharge test at 0.1 C for Example 1.

FIG. 7 is a diagram illustrating the results of a charge and discharge test at 0.2 C for Example 1.

FIG. 8 is a diagram illustrating the number of cycles and the discharge capacity for Example 1 and α-Li₃ScCl₆.

### DESCRIPTION OF EMBODIMENTS

A compound of the present embodiment contains an alkali metal element, at least one metal element M selected from the group consisting of Mg, Ca, Sr, Ba, Zn, Sc, La, Ce, Pr, Nd, Pm, Sm, Eu, Gd, Tb, Dy, Ho, Er, Yb, Lu, Y, Al, Ga, In, Bi, Sb, Ge, Ti, Zr, Hf, Sn, Nb, Ta, and W, and a halogen element, and has a crystal structure belonging to a space group P6₃mc. Hereinafter, the compound of the present embodiment is also referred to as an alkali metal element-containing halide. Such a compound is excellent in ionic conductivity. Therefore, the compound can be used as an ion conductive substance containing the alkali metal element-containing halide of the present embodiment.

The crystal structure can be identified by X-ray diffraction measurement. In particular, the crystal structure can be identified by Rietveld analysis.

In addition, there is room for improvement in electrochemical stability of a halide solid electrolyte, and for example, in a case where the halide solid electrolyte is used as a solid electrolyte, a short circuit may occur in a battery unless a sulfide separation membrane is disposed between the halide solid electrolyte and a negative electrode. The alkali metal element-containing halide of the present embodiment also tends to be excellent in electrochemical stability.

The alkali metal element contained in the alkali metal element-containing halide of the present embodiment may be any of Li, Na, K, Rb, and Cs, but may include at least one of Li, Na, or K, may include at least one of Li or Na, or may include Li.

Among the alkali metal elements contained in the alkali metal element-containing halide, a proportion of one alkali metal element may be 80% by mol or more, 90% by mol or more, or 95% by mol or more. The one alkali metal element may be at least one of Li, Na, or K, may be at least one of Li or Na, or may be Li.

A content of the alkali metal element in the alkali metal element-containing halide may be 10% to 40% by mol, 15% to 35% by mol, or 20% to 30% by mol with respect to the total amount of atoms contained in the alkali metal element-containing halide.

The metal element M may include at least one element selected from the group consisting of La, Y, Ga, In, Sc, Bi, Sb, Ge, Zr, Sn, Nb, and Ta, may include at least one element selected from the group consisting of Ga, In, Sc, La, Y, Sb, and Bi, may include at least one element selected from the group consisting of Ga, In, Sc, and La, or may include Sc.

The alkali metal element-containing halide may contain one metal element M alone, but may contain two or more metal elements M. The alkali metal element-containing halide may also contain a trivalent metal element M. In a case where two or more metal elements M are contained, two or more trivalent metal elements M may be contained, but a trivalent metal element M and a metal element M having a valence other than trivalence (for example, divalent or tetravalent or higher, or tetravalent) may be contained. Examples of a divalent metal element M include Mg, Ca, Sr, Ba, and Zn. Examples of a trivalent metal element M include Sc, La, Ce, Pr, Nd, Sm, Eu, Gd, Tb, Dy, Ho, Er, Yb, Lu, Y, Al, Ga, In, Bi, and Sb. Examples of a tetravalent metal element M include Ge, Ti, Zr, Hf, and Sn. Examples of a pentavalent metal element M include Nb, Ta, Sb, and Bi. In a case where the alkali metal element-containing halide contains two or more metal elements M, the metal element M may include Sc and at least one element selected from the group consisting of La, Y, Ga, In, Bi, Sb, Ge, Zr, Sn, Nb, and Ta, or may include Sc and at least one element selected from the group consisting of Ga, Bi, Sb, Ge, Zr, Sn, Nb, and Ta.

A content of the trivalent metal element among the metal elements M may be 30% by mol or more, 40% by mol or more, 50% by mol or more, 80% by mol or more, 90% by mol or more, or 95% by mol or more. A content of Sc among the metal elements M may be 30% by mol or more, 40% by mol or more, 50% by mol or more, 80% by mol or more, 90% by mol or more, or 95% by mol or more.

The metal element M may include a trivalent metal element and a metal element other than the trivalent metal element. The metal element other than the trivalent metal element may be a tetravalent metal element or a pentavalent metal element, and may be at least one element selected from the group consisting of Ga, Ge, Sn, Zr, Bi, Nb, and Ta. A content of the metal element other than the trivalent metal element among the metal elements M may be 50% by mol or less, 30% by mol or less, 20% by mol or less, 15% by mol or less, or 10% by mol or less.

A content of the metal element Min the alkali metal element-containing halide may be 5% to 20% by mol, 8% to 15% by mol, or 10% to 15% by mol with respect to the total amount of atoms contained in the alkali metal element-containing halide.

The halogen element contained in the alkali metal element-containing halide of the present embodiment may be any of F, Cl, Br, and I, but may include at least one of Cl, Br, or I, may include at least one of F, Cl, or Br, may include at least one of F or Cl, and may include Cl. The alkali metal element-containing halide may contain one halogen element alone, but may contain two or more halogen elements. In a case where the alkali metal element-containing halide contains two or more halogen elements, the alkali metal element-containing halide may contain Cl and at least one of halogen elements other than Cl, or may contain Cl and F.

A content of the halogen element in the alkali metal element-containing halide may be 40% to 80% by mol, 50% to 70% by mol, or 55% to 65% by mol with respect to the total amount of atoms contained in the alkali metal element-containing halide. A content of Cl in the alkali metal element-containing halide may be 50% by mol or more, 60% by mol or more, 70% by mol or more, or 80% by mol or more with respect to the total amount of the halogen elements contained in the alkali metal element-containing halide. A content of a halogen element other than Cl in the alkali metal element-containing halide may be 50% by mol or less, 40% by mol or less, 30% by mol or less, or 20% by mol or less with respect to the total amount of the halogen elements contained in the alkali metal element-containing halide. A content of the halogen element other than Cl in the alkali metal element-containing halide may be 0.5% by mol or more, 1% to 30% by mol, or 3% to 20% with respect to the total amount of the halogen elements contained in the alkali metal element-containing halide. A content of F in the alkali metal element-containing halide may be 50% by mol or less, 40% by mol or less, 30% by mol or less, or 20% by mol or less with respect to the total amount of the halogen elements contained in the alkali metal element-containing halide. A content of F in the alkali metal element-containing halide may be 0.5% by mol or more, 1% to 30% by mol, or 3% to 20% with respect to the total amount of the halogen elements contained in the alkali metal element-containing halide.

The alkali metal element-containing halide may be represented by the following Composition Formula (1).

A_{α}M_{β}X_{γ}Z_{δ} (1)

(In Formula, A is an alkali metal element, X is a halogen element, Z is an element other than A, M, and X, 1≤α≤4, 0.5≤β≤2, 4≤γ≤8, and 0≤δ≤0.5.)

α may be 1.5 to 3.5 or 2 to 3.2. β may be 0.8 to 1.5 or 1 to 1.5. γ may be 5 to 7 or 5.5 to 6.5. α may be 2.1 to 3.1 or 2.3 to 3.05.

β may be 0.9 to 1.4 or 0.95 to 1.3.

γ may be 5.7 to 6.3 or 5.9 to 6.1.

δ may be 0 to 0.1, 0 to 0.01, or 0 to 0.001, or δ may be 0.

An element that can be introduced as Z is not particularly limited, and may be, for example, at least one selected from the group consisting of C, N, P, O, and S, or at least one selected from the group consisting of N, P, and S.

Examples of a method for producing the alkali metal element-containing halide of the present embodiment include a method including a step of heating a raw material under a pressure of 1 GPa or higher. The heating temperature may be 200° C. or higher.

The pressure for pressurization is preferably 2 GPa or higher, and more preferably 4 GPa or higher. In addition, the pressure is preferably 15 GPa or lower, and preferably 10 GPa or lower. The upper limit and the lower limit can be optionally combined. It is easy to stabilize the structure of the alkali metal element-containing halide by the control of the pressure within this range.

The heating temperature is more preferably 250° C. or higher. The heating temperature is preferably 1,500° C. or lower, and preferably 1,300° C. or lower. It is easy to stabilize the structure of the alkali metal element-containing halide of the present embodiment by the control of the temperature within this range.

The temperature increasing rate may be 5° C./min to 200° C./min, 10° C./min to 150° C./min, 20° C./min to 100° C./min, or 30° C./min to 80° C./min. The time required to reach the desired heating temperature from the ambient temperature (for example, 25° C.) may be 0.1 to 45 minutes, 1 to 30 minutes, 5 to 25 minutes, or 10 to 20 minutes.

The temperature decreasing rate may be 50° C./min to 500° C./min, 80° C./min to 400° C./min, 100° C./min to 300° C./min, or 150° C./min to 250° C./min. The time required to reach the ambient temperature (for example, 25° C.) from the heating temperature may be 0.1 to 20 minutes, 0.5 to 15 minutes, 1 to 10 minutes, or 2 to 8 minutes.

The holding time at the heating temperature may be 0.1 to 10 hours, 0.5 to 7 hours, or 1 to 5 hours.

The heating may be performed after the pressure is applied until the pressure reaches a predetermined pressure. In addition, the pressure may be lowered after the temperature is decreased to a predetermined temperature.

Examples of the raw material include halides of alkali metals and halides of the metal element M.

The alkali metal element-containing halide of the present embodiment can be used, for example, as a material of electrochemical devices such as a capacitor and a battery. Examples of such a material include a material of an electrolyte (solid electrolyte). Examples of the battery include batteries such as a lithium ion battery and a sodium ion battery, which are charged and discharged by movement of alkali metal ions between a positive electrode and a negative electrode. In addition, the alkali metal element-containing halide of the present embodiment can be used as an electrode material, and may be contained in at least one of the positive electrode or the negative electrode.

Hereinafter, the battery of the present embodiment will be described using a lithium ion battery as an example. The lithium ion battery includes a positive electrode, a negative electrode, and an electrolyte (solid electrolyte) disposed between the positive electrode and the negative electrode. The alkali metal element-containing halide (in this case, a lithium-containing halide) of the present embodiment may be contained in the electrolyte of the lithium ion battery.

The positive electrode of the lithium ion battery is not particularly limited and contains a positive electrode active material, and may contain a conductive additive, a binder, and the like as necessary.

The positive electrode may have a configuration in which a layer that contains these materials is formed on a current collector. Examples of the positive electrode active material include a lithium-containing composite metal oxide containing lithium (Li) and at least one transition metal selected from the group consisting of V, Cr, Mn, Fe, Co, Ni, and Cu. Examples of such a lithium composite metal oxide include LiCoO₂, LiNiO₂, LiMn₂O₄, Li₂MnO₃, LiNiₓMn_{y}Co_{1-x-y}O₂ [0<x+y<1]), LiNiₓCo_{y}Al_{1-x-y}O₂ [0<x+y<1]), LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄.

The negative electrode of the lithium ion battery is not particularly limited and contains a negative electrode active material, and may contain a conductive additive, a binder, and the like as necessary. Examples thereof include metals such as Li, Si, P, Sn, Si—Mn, Si—Co, Si—Ni, In, and Au, alloys containing these metals, carbon materials such as graphite, and substances in which lithium ions are intercalated between layers of the carbon materials.

The material of the current collector is not particularly limited, and may be a single metal element such as Cu, Mg, Ti, Fe, Co, Ni, Zn, Al, Ge, In, Au, Pt, Ag, or Pd, or an alloy.

A solid electrolyte layer may include a plurality of layers. For example, in addition to the solid electrolyte layer containing the lithium-containing halide of the present embodiment, a sulfide solid electrolyte layer may be included. The sulfide solid electrolyte layer may be included between the solid electrolyte containing the lithium-containing halide of the present embodiment and the negative electrode.

Note that, since the solid electrolyte layer containing the lithium-containing halide of the present embodiment has high electrochemical stability, a short circuit in the battery is unlikely to occur even in direct contact with the negative electrode without the sulfide solid electrolyte layer. The sulfide solid electrolyte is not particularly limited, and examples thereof include Li₆PS₅Cl, Li₂S—PS₅, Li₁₀GeP₂S₁₂, Li_{9.6}P₃S₁₂, Li_{9.54}Si_{1.74}P_{1.44}S_{11.7}Cl_{0.3}, and Li₃PS₄.

### EXAMPLES

### Example 1: Synthesis of Hexagonal Li₃ScCl₆ (γ-Li₃ScCl₆)

In order to synthesize γ-Li₃ScCl₆, first, stoichiometric amounts of LiCl and ScCl₃ were mixed in a glove box under a nitrogen atmosphere. Then, the mixture was pressed together with gold foil as a protective material to form pellets. Typically, the pellets were inserted into a hand-made gold crucible boron nitride (BN) covered sleeve tube. Next, the sample and sleeve were inserted into a graphite tube and encapsulated in a pyrophyllite cube for a high pressure reaction. The sample cell was pressed for 1 hour to reach 5 GPa and then heated to 1,000° C. for 3 hours. After holding the sample cell at this temperature for 3 hours, the sample was quenched to room temperature within 5 minutes, and the pressure was then released to set the atmospheric pressure for 2 hours. As a result, a lithium-containing chloride (γ-Li₃ScCl₆) was obtained.

### Example 1′

A lithium-containing chloride was produced in the same manner as in Example 1, except that the sample cell was pressed for 2 hours to reach 8 GPa, followed by releasing the pressure and setting the atmospheric pressure for 12 hours.

### <Evaluation of Crystal Structure>

A colorless transparent plate-like crystal was selected for structure determination. Single crystal X-ray structure determination (XRD) data were obtained by monochromated MoK, radiation (λ=0.7107 Å) at 123 K using a Bruker Kappa APEX 2 CCD diffractometer. The distance between the crystal and the detector was adjusted to 50 mm. The SAINT program was used for data reduction and integration. The structure was established by direct methods and optimized using full-matrix least-squares fitting based on F² with OLEX2. All atoms were optimized by the full-matrix least-squares method, and the final least squares optimization was based on F₀² with F₀²≥2σ(F₀²). Numerical absorption corrections were performed using the SADABS program for the surface detector. The structure was analyzed using SHEL-XS to determine the atomic coordinates of the metal cations.

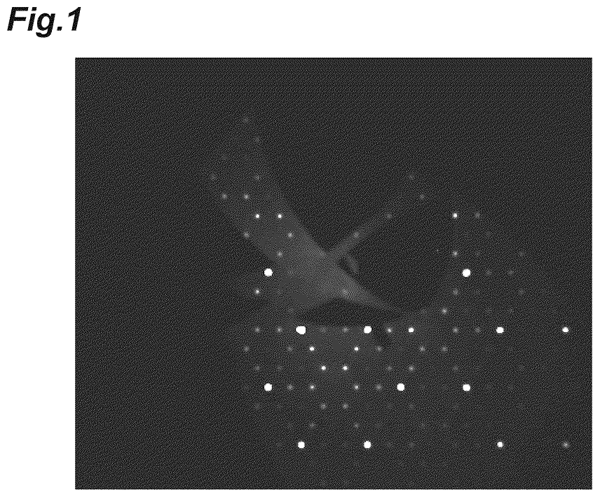

As a representative X-ray diffraction pattern of a single crystal, FIG. 1 illustrates X-ray diffraction measurement corresponding to the c-axis direction (001 direction) for the sample of Example 1.

### Examples 2 to 4

Lithium-containing chlorides were produced in the same manner as in Example 1 except that LiCl and ScCl₃ were used in amounts to give the compositions illustrated in Table 2.

### Example 5

A lithium-containing chloride was produced in the same manner as in Example 1 except that LiCl, ZrCl₄, and ScCl₃ were used in amounts to give the compositions illustrated in Table 2.

### Example 20

A lithium-containing chloride was produced in the same manner as in Example 1 except that LiCl, LiF, and ScCl₃ were used in amounts to give the compositions illustrated in Table 2.

### Comparative Example 1

### Ball Milling

In an argon atmosphere having a dew point of −70° C. or lower (hereinafter, referred to as a dry argon atmosphere), 0.3201 g of LiCl and 0.8799 g of ZrCl₄ were weighed to prepare a raw material.

The above-described raw material was put in a zirconia pot having a volume of 50 ml for the following planetary ball mill, and 65 g of zirconia balls having a diameter of 4 mm were put therein. A crude composition of Comparative Example 1 was obtained by performing a treatment to cause a mechanochemical reaction under the conditions of 48 hours and 380 rpm. The ball mill was operated in a mode in which the ball mill rotates for 10 minutes, followed by a 1-minute stop as an interval, and the rotation direction is alternately switched between clockwise and counterclockwise. The starting composition of the lithium-containing chloride is Li₂ZrCl₆.

Planetary ball mill machine: PM 400 manufactured by Verder Scientific GmbH & Co. KG

### Annealing

The crude composition of Comparative Example 1 obtained as described above was heated at 230° C. for 5 hours in an argon atmosphere to obtain a lithium-containing chloride of Comparative Example 1 with a starting composition of Li₂ZrCl₆.

### <Powder X-Ray Diffraction Measurement>

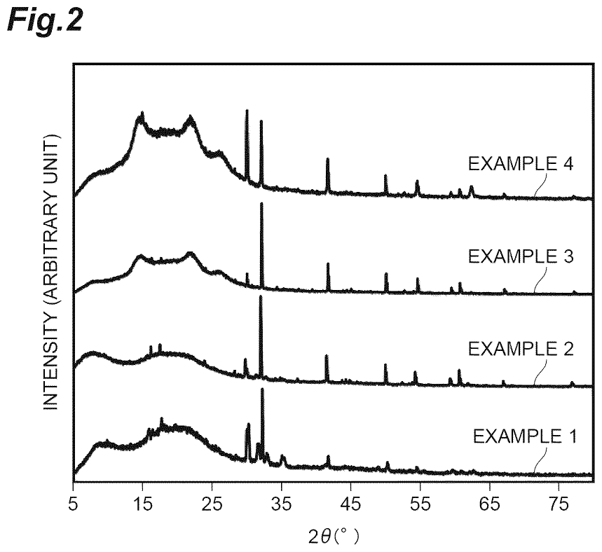

The crystal structure of the obtained lithium-containing halide was evaluated by powder X-ray diffraction measurement at 25° C. The results are illustrated in Table 2. In addition, FIG. 2 illustrates diffraction patterns of Examples 1 to 4. It was confirmed that all of the examples had a diffraction peak attributed to the crystal structure of the space group P6₃mc. The powder X-ray diffraction measurement was performed under the following measurement conditions. In addition, the sample space was protected with a polyimide tape in the glove box so that the sample was not directly exposed to the atmosphere, and the measurement was then performed.
Measuring apparatus: SmartLab (manufactured by Rigaku Holdings Corporation)
X-ray generator: CuKα source, voltage 40 kV, current 50 mA
X-ray detector: Semiconductor detector
Measurement range: Diffraction angle 2θ=5° to 80°
Scan speed: 2.5°/min
   (Synthesis of α-Li₃ScCl₆)

α-Li₃ScCl₆ was obtained by heating a stoichiometric mixture of LiCl and ScCl₃ in a sealed silica tube at 650° C. for 12 hours. Note that the temperature increasing rate during heating was 2° C./min, and the temperature decreasing rate was also 2° C./min.

(Synthesis of β-Li₃ScCl₆)

Stoichiometric amounts of LiCl and ScCl₃ were mixed. The mixture was pelletized and placed in a sealed quartz tube under vacuum. The sample was obtained by heating at 650° C. for 48 hours. Note that the temperature increasing rate during heating and the temperature decreasing rate were 5° C./min.

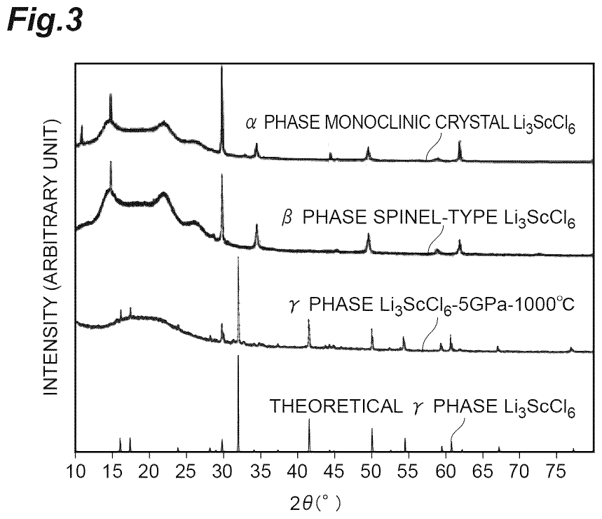

FIG. 3 is an X-ray diffraction chart of three crystal polymorphs of Li₃ScCl₆ obtained by performing a powder X-ray diffraction measurement on a sample pulverized in an agate mortar under the same conditions as those in the powder X-ray diffraction measurement described above. It is known that Li₃ScCl₆ has two crystal polymorphs of an α phase (α-Li₃ScCl₆) having a monoclinic (space group: C2/m) crystal structure and a β phase (β-Li₃ScCl₆) having a cubic (space group: Fd-3m) crystal structure. As illustrated in FIG. 3, Li₃ScCl₆ synthesized as described above has a hexagonal (space group: P6₃mc) crystal structure, and has a novel crystal structure different from both the a phase and the p phase. Li₃ScCl₆ having this novel crystal structure is also referred to as γ-Li₃ScCl₆. In addition, the crystal structure data obtained by the single crystal X-ray structural analysis described above was used to obtain the diffraction chart of the γ-phase of Li₃ScCl₆ by inputting the wavelength of CuKα radiation (1.54059 Å) and performing a simulation (theoretical calculation). with the crystal structure analysis software VESTA (Visualization for Electronic and Structural Analysis). The obtained diffraction chart also matches well with the diffraction chart (lowest graph) of the γ-phase of Li₃ScCl₆ obtained by theoretical calculation.

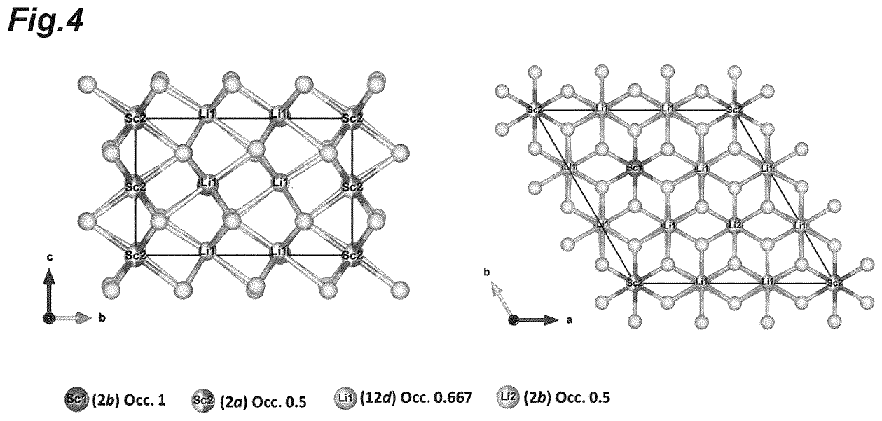

Table 1 illustrates γ-Li₃ScCl₆ crystal data and structure optimization data obtained from single crystal X-ray diffraction at 123 K. Li₃ScCl₆-5 GPa and Li₃ScCl₆-8 GPa mean samples (that is, Example 1 and Example 1′) obtained under pressures of 5 GPa and 8 GPa, respectively. FIG. 4 is a ball-and-stick and polyhedral representation of the structure of γ-Li₃ScCl₆.

TABLE 1

| Identification code | Li₃ScCl₆-5GPa | Li₃ScCl₆-8GPa |
|---|---|---|
| Empirical formula | Li₃ScCl₆ | Li₃ScCl₆ |
| Formula mass | 278.48 | 278.48 |
| Temperature/K | 123 | 123 |
| Crystal system | Hexagonal | hexagonal |
| Space group | P6₃mc | P6₃mc |
| a/Å | 10.831(6) | 10.842(5) |
| b/Å | 10.831(6) | 10.842(5) |
| c/Å | 5.924(3) | 5.922(3) |
| α/° | 90 | 90 |
| β/° | 90 | 90 |
| γ/° | 120 | 120 |
| Volume/Å³ | 601.88(7) | 602.88(6) |
| Z | 3 | 3 |
| ρ_{calc}g/cm³ | 2.305 | 2.301 |
| μ/mm⁻¹ | 2.809 | 2.804 |
| F(000) | 396.0 | 396.0 |
| Crystal size/mm³ | 0.03 × 0.03 × 0.02 | 0.04 × 0.03 × 0.02 |
| Radiation | Mo Kα (λ = 0.71073) | Mo Kα (λ = 0.71073) |
| Data collected 2θ range/° | 7.524 to 63.514 | 7.518 to 64.45 |
| Index range | −16 ≤ h ≤ 12, −10 ≤ k ≤ 10, −8 ≤ l ≤ 8 | −9 ≤ h ≤ 16, −16 ≤ k ≤ 11, −8 ≤ l ≤ 8 |
| Collected reflection | 3328 | 5171 |
| Independent reflections | 754 [Rᵢₙₜ = 0.0149, R_{sigma} = 0.0189] | 784 [Rᵢₙₜ = 0.0180, R_{sigma} = 0.0169] |
| Data/Constraints/Parameters | 754/1/37 | 784/1/37 |
| Goodness-of-fit on F² | 1.117 | 1.191 |
| Final R indices [I >= 2σ (I)] | R1 = 0.0212, wR2 = 0.0482 | R₁ = 0.0225, wR₂ = 0.0511 |
| Final R indices [All Data] | R1 = 0.0252, wR2 = 0.0506 | R₁ = 0.0254, wR₂ = 0.0520 |
| Maximum diffraction peak/hole/e Å⁻³ | 0.56/−0.28 | 0.87/−0.33 |
| Flack parameter | −0.3(2) | 0.15(18) |

### <Evaluation of Ionic Conductivity>

A press molding die including a frame, a punch lower part, and a punch upper part were prepared. The frame was formed of insulating polycarbonate. In addition, both the punch upper part and the punch lower part were formed of electron-conductive stainless steel, and were electrically connected to terminals of an impedance analyzer (Sl 1260 manufactured by Solatron Analytical).

The ionic conductivity of the lithium-containing halide was measured by the following method using the press molding die. First, filling of a lithium-containing halide powder onto the punch lower part inserted vertically downward into a hollow section of the frame was carried out in a dry argon atmosphere. Then, the punch upper part was pressed toward the hollow section of the frame from above to apply a pressure of 370 MPa to the lithium-containing halide powder inside the press molding die. After the pressure was applied, a punch was fastened and fixed vertically with a jig, and the impedance of the lithium’-containing halide was measured by an electrochemical impedance measurement method using the impedance analyzer with a constant pressure maintained.

From the impedance measurement results, a graph of a Cole-Cole plot was created. In the Cole-Cole plot, the real part of the impedance at the measurement point where the absolute value of the phase of the complex impedance is the smallest was regarded as a resistance value to ion conduction of the halide solid electrolyte material. The resistance value was used to calculate the ionic conductivity based on the following Formula (III). The ionic conductivity at 25° C. (σ_{25° C.}) of each sample is illustrated in Table 2.

σ=(R_{SE}×S/t)⁻¹ (III)

In the formula,
σ is an ionic conductivity,
S is a contact area of the lithium-containing halide with the punch upper part (equal to the cross-sectional area of the hollow section of the frame),
R_{SE} is a resistance value of the solid electrolyte material in impedance measurement, and
t is a thickness of the lithium-containing halide when pressure is applied.

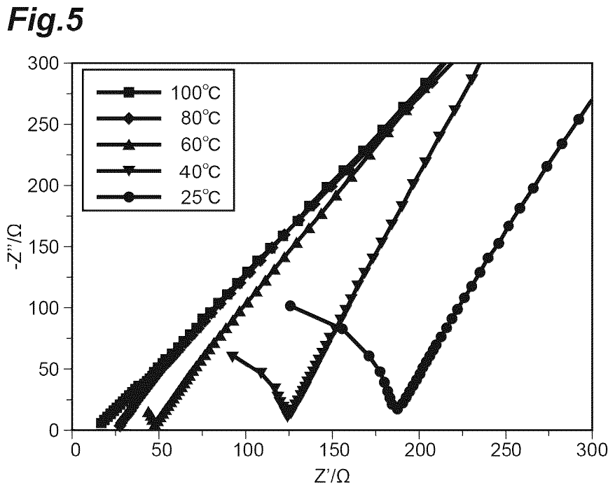

FIG. 5 is a Cole-Cole plot of the ionic conductivity of Example 3. FIG. 5 illustrates the measurement results at 25° C., 40° C., 60° C., 80° C., and 100° C.

### <Preparation of Secondary Battery>

In a dry argon atmosphere, a lithium-containing halide, LiNi_{1/3}Mn_{1/3}Co_{1/3}O₂, and acetylene black were weighed as 29 parts by mass, 67 parts by mass, and 4 parts by mass respectively, and mixed in a mortar to obtain a mixture.

In an insulating cylinder having an inner diameter of 10 mm, 100 mg of the lithium-containing halide and 15 mg of the above-described mixture were sequentially laminated to obtain a laminate. A pressure of 370 MPa was applied to the laminate to form a first electrode (the layer of the mixture) and a solid electrolyte layer (the layer of the lithium-containing halide).

Next, 60 mg of an In foil was added so as to come into contact with the solid electrolyte layer, and 2 mg of a Li foil was further added so as to come into contact with the In foil to obtain a laminate. A pressure of 370 MPa was applied to the laminate to form a second electrode.

A current collector formed of stainless steel was attached to the first electrode and the second electrode, and lead wires were then attached to the current collector. All the members were disposed in a desiccator and were sealed, and thus a secondary battery was obtained.

### <Charge and Discharge Test>

As a charge and discharge tester, the following product was used.

Charge and discharge tester: TOSCAT-3100 manufactured by Toyo System Co., Ltd.

A charge and discharge test was performed at 60° C. at three C rates of 0.1 C, 1 C, and 3 C.

Charging was performed up to 3.7 V at a current density corresponding to each C rate at a constant current and a constant voltage (CCCV charging).

Discharging was performed up to 1.9 V at a current density corresponding to each C rate.

A case where there was no short circuit after the secondary battery was produced, an open circuit voltage was obtained, and the charge capacity and discharge capacity were confirmed in the above-described charge and discharge test was determined as chargeable and dischargeable

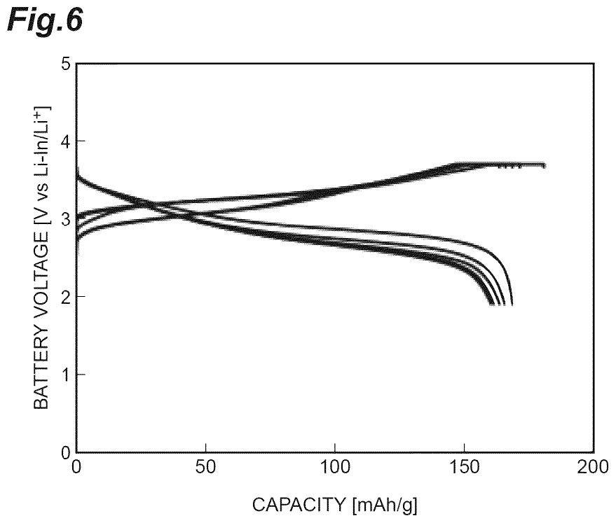

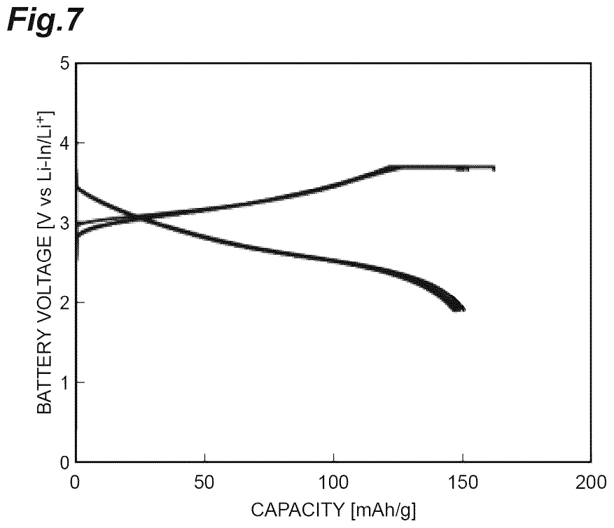

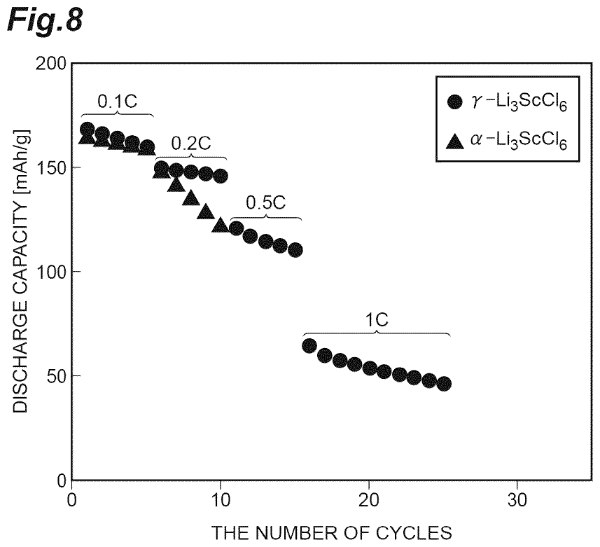

In addition, in Example 1, the charge and discharge test was performed 5 times at C rates of 0.1 C and 0.2. FIG. 6 is a diagram illustrating the results of the charge and discharge test at 0.1 C for Example 1. FIG. 7 is a diagram illustrating the results of the charge and discharge test at 0.2 C for Example 1. FIG. 8 is a diagram illustrating the number of cycles and the discharge capacity for Example 1 and α-Li₃ScCl₆. FIG. 8 illustrates the discharge capacity of γ-Li₃ScCl₆ measured at a C rate of 0.1 C, 0.2 C, and 0.5 C for 5 cycles for each rate, and the discharge capacity of γ-Li₃ScCl₆ measured at 1 C for 10 cycles thereafter. In addition, the discharge capacity of α-Li₃ScCl₆ measured at C rates of 0.1 C and 0.2 C for 5 cycles are illustrated.

TABLE 2

| | | | Evaluation | Ionic | |
|---|---|---|---|---|---|
| | Starting | Space | of Li—In | conductivity | |
| | composition | group | battery | (σ25° C.) | |
| Example 1 | Li₃ScCl₆ | P6₃mc | Chargeable and | 0.24 | mS/cm |
| | | | dischargeable | | |
| Example 2 | Li_{2.85}Sc_{1.05}Cl₆ | P6₃mc | — | 0.56 | mS/cm |
| Example 3 | Li_{2.4}Sc_{1.2}Cl₆ | P6₃mc | Chargeable and | 0.70 | mS/cm |
| | | | dischargeable | | |
| Example 4 | Li_{2.1}Sc_{1.3}Cl₆ | P6₃mc | — | 0.17 | mS/cm |
| Example 5 | Li_{2.6}Sc_{0.6}Zr_{0.4}Cl₆ | P6₃mc | — | 0.096 | mS/cm |
| Example 20 | Li₃ScCl_{5.4}F_{0.6} | P6₃mc | — | 0.13 | mS/cm |
| Comparative | Li₂ZrCl₆ | C2/m | Short circuit | 0.023 | mS/cm |

Example 1

In the lithium-containing chlorides of Examples 1 to 5 and 20, favorable ionic conductivity was obtained as compared with Comparative Example.

### <Calculation of Li Ion Diffusion Behavior and Evaluation of Calculation Result>

The Li ion diffusion behavior was determined by calculating the mean-square displacement of Li in the compound belonging to the space group P6₃mc based on molecular dynamics simulation.

Without currently wishing to limit the scope of the claims, all Li-ion diffusion behaviors and the resultant mean-square displacements illustrated in the present application were calculated using the computational chemistry software “Vienna ab initio simulation package (VASP)” provided by the University of Vienna, Republic of Austria, which is widely used and known to those skilled in the art.

Specifically, molecular dynamics calculation was carried out using a supercell having 36 Li atoms, 12 trivalent atoms, and 72 Cl atoms, and the mean-square displacement of Li was determined. For the element substitution structure, element substitution was carried out based on this structure using the above-described method. As the calculation conditions, a density functional PBE was used, an nPT ensemble was used, a time interval was 1 fs, a simulation time was 300 ps, and MD calculation was carried out at a simulation temperature of 700 K. The non-integer occupancy sites of trivalent atoms were selected to be occupied or occupied according to the occupancy rate to achieve the most stable thermodynamics.

The mean-square displacement of Li ions was determined by the following Formula (nn).

Mean-square displacement of Li-ion=(Σₙ(r(n,t)−r(n,0))²)/N (nn)

In the formula, r(n,t) is a coordinate of an n-th Li atom at a time t, and N is the total number of Li contained in the calculation cell.

### Example 1

For γ-Li₃ScCl₆ of Example 1, the mean-square displacement of Li in the compound was calculated and determined based on the molecular dynamics simulation. The results are described in Table 3 below.

### Examples 6 to 11

For a compound with a crystal structure similar to that of γ-Li₃ScCl₆, in which the Sc element substituted with a trivalent element, the mean-square displacement of Li in the compound was calculated and determined based on molecular dynamics simulation. The results are described in Table 3 below.

### Example 12

For a compound with a crystal structure similar to that of γ-Li₃ScCl₆, in which the site of the Sc element is occupied by two trivalent elements, the mean-square displacement of Li in the compound was calculated and determined based on molecular dynamics simulation. For reference, an example in which each of Ga and Sc occupies the site by 50% by mol is exemplified, but this does not exclude other compositions. The results are described in Table 3 below.

### Examples 13 to 19

For a compound in which one Sc atom of γ-Li₃ScCl₆ in the supercell is substituted with a tetravalent or pentavalent element, the mean-square displacement of Li in the compound was calculated and determined based on molecular dynamics simulation. In this model, in a case where the Sc atoms were substituted with the tetravalent elements, Li atoms equivalent to the number of substituted atoms were removed from the nearest sites as charge compensation. In addition, in a case where the Sc atoms were substituted with the pentavalent elements, Li atoms equivalent to twice the number of substituted atoms were removed from the nearest sites as charge compensation. As a constraint of the calculation model, a composition with Sc substituted by about 8% by mol is exemplified, but this does not exclude other compositions. The obtained results are described in Table 3 below.

TABLE 3

| | | | Ionic | Mean-squared |
|---|---|---|---|---|
| | | | conductivity | displacement |
| | Compound | Space group | (mS/cm) | (Å²) |
| Example 1 | Li₃ScCl₆ | P6₃mc | 0.24 | 110.4 |
| Example 6 | Li₃BiCl₆ | P6₃mc | — | 24.5 |
| Example 7 | Li₃GaCl₆ | P6₃mc | — | 230.3 |
| Example 8 | Li₃InCl₆ | P6₃mc | — | 111.5 |
| Example 9 | Li₃LaCl₆ | P6₃mc | — | 70.6 |
| Example 10 | Li₃SbCl₆ | P6₃mc | — | 35.5 |
| Example 11 | Li₃YCl₆ | P6₃mc | — | 38.8 |
| Example 12 | Li₃Sc_{0.5}Ga_{0.5}Cl₆ | P6₃mc | — | 159.5 |
| Example 13 | Li_{2.92}Sc_{0.92}Ge_{0.08}Cl₆ | P6₃mc | — | 147.3 |
| Example 14 | Li_{2.92}Sc_{0.92}Sn_{0.08}Cl₆ | P6₃mc | — | 98.8 |
| Example 15 | Li_{2.92}Sc_{0.92}Zr_{0.08}Cl₆ | P6₃mc | — | 152.3 |
| Example 16 | Li_{2.83}Sc_{0.92}Bi_{0.08}C1₆ | P6₃mc | — | 177.9 |
| Example 17 | Li_{2.83}Sc_{0.92}Nb_{0.08}Cl₆ | P6₃mc | — | 137.1 |
| Example 18 | Li_{2.83}Sc_{0.92}Sb_{0.08}Cl₆ | P6₃mc | — | 125.8 |
| Example 19 | Li_{2.83}Sc_{0.92}Ta_{0.08}Cl₆ | P6₃mc | — | 123.5 |
| Comparative | Li₃AlF₆ | Pna2₁ | — | 1.4 |
| Example 3 | | | | |
| Comparative | Li₆CsCl₂ | C12/c1 | — | 0.2 |
| Example 4 | | | | |
| Comparative | Li₆VCl₈ | Fm-3m | — | 0.2 |
| Example 5 | | | | |
| Comparative | Li₆CoCl₈ | Fm-3m | — | 0.3 |
| Example 6 | | | | |
| Comparative | Li₂ZnCl₄ | Fd-3m | — | 0.3 |
| Example 7 | | | | |

As illustrated in Table 3 above, each of the compounds of Examples 1 and 6 to 19 exhibits a mean-square displacement of Li ions of several Å² or more. The mean-square displacement of greatly exceeding several Å² means that Li is diffused in the solid, and the solid electrolyte is capable of conducting Li.

1. A compound comprising:
an alkali metal element;
at least one metal element M selected from the group consisting of Mg, Ca, Sr, Ba, Zn, Sc, La, Ce, Pr, Nd, Pm, Sm, Eu, Gd, Tb, Dy, Ho, Er, Yb, Lu, Y, Al, Ga, In, Bi, Sb, Ge, Ti, Zr, Hf, Sn, Nb, Ta, and W; and
a halogen element, wherein
the compound has a crystal structure belonging to a space group P6₃mc.

2. The compound according to claim 1, wherein the halogen element contains Cl.

3. The compound according to claim 1, wherein the metal element includes a trivalent metal element.

4. The compound according to claim 1, wherein the compound is represented by Composition Formula (1),
A_{α}M_{β}X_{γ} (1)
(where, A is an alkali metal element, X is a halogen element, and 1≤α≤4, 0.5≤β≤2, and 4≤γ≤8).

5. The compound according to claim 1, wherein the metal element M includes at least one element selected from the group consisting of Ga, In, Sc, La, Y, Sb, and Bi.

6. The compound according to claim 1, wherein the metal element M includes two or more metal elements.

7. The compound according to claim 1, wherein the halogen element includes two or more halogen elements.

8. An electrolyte comprising the compound according to claim 1.

9. A battery comprising the electrolyte according to claim 8.

10. A method for producing a halide solid electrolyte, the method comprising a step of heating a raw material under a pressure of 1 GPa or higher.

11. The compound according to claim 2, wherein the metal element includes a trivalent metal element.

12. The compound according to claim 2, wherein the compound is represented by Composition Formula (1),
A_{α}M_{β}X_{γ} (1)
(where, A is an alkali metal element, X is a halogen element, and 1≤α≤4, 0.5≤β≤2, and 4≤γ≤8).

13. The compound according to claim 2, wherein the metal element M includes at least one element selected from the group consisting of Ga, In, Sc, La, Y, Sb, and Bi.

14. The compound according to claim 2, wherein the metal element M includes two or more metal elements.

15. The compound according to claim 2, wherein the halogen element includes two or more halogen elements.
